(19) United States
(12) Patent Application Publication
(10) Pub. No.: US 2012/0239247 A1
(43) Pub. Date: Sep. 20, 2012

(54) SYSTEMS AND METHODS FOR ACTIVE MITIGATION OF SUDDEN ACCELERATIVE FORCES IN VEHICLES

(75) Inventor: James Michael Eridon, Shelby Township, MI (US)

(73) Assignee: GENERAL DYNAMICS LAND SYSTEMS, INC., Sterling Heights, MI (US)

(21) Appl. No.: 13/211,991

(22) Filed: Aug. 17, 2011

Related U.S. Application Data
(60) Provisional application No. 61/453,421, filed on Mar. 16, 2011.

(51) Int. Cl. G06F 7/00

(52) U.S. Cl. 701/36; 701/1

(57) ABSTRACT

An active blast mitigation system includes one or more sensors configured to produce a set of acceleration signals indicative of a dynamic response of the vehicle. A control system communicatively coupled to the plurality of sensors is configured to determine the dynamic response of the vehicle based on the set of acceleration signals and determine whether mitigation is required based on the dynamic response of the vehicle. If it is determined that mitigation is required, the control system produces one or more countermeasure signals selected to at least partially counteract the dynamic response. Countermeasure assemblies communicatively coupled to the control system are configured to activate in response to the one or more countermeasure signals.

### CROSS-REFERENCE TO RELATED APPLICATIONS

This application claims priority to U.S. Prov. Pat. No. 61/453,421, filed Mar. 16, 2011, which is hereby incorporated by reference.

### FIELD OF THE INVENTION

This invention generally relates to vehicular safety systems, and more particularly relates to systems and methods for mitigating the effects of sudden accelerative forces on vehicles due to, for example, land mines and improvised explosive devices (IEDs).

### BACKGROUND OF THE INVENTION

Vehicles, particularly military vehicles, often experience sudden accelerative forces due to land mine blasts, improvised explosive devices (IEDs), and other types of explosive events. In many cases, the basic hull structure of the vehicle is sufficiently robust and structurally sound to withstand such blasts. However, even when the hull itself is intact, the sudden rotation and/or translation of the vehicle can cause excessive and possibly fatal accelerative forces on the occupants of the vehicle.

For example, in the event that a land mine explodes near the front end of a vehicle, the upward blast force experienced by the underbelly of the vehicle will often cause sudden upward rotation of the vehicle's front end accompanied by a general upward translation of the vehicle. While various restraint systems such as break-away seating have been proposed to address this problem, such sudden accelerations can still pose a major survivability risk to the occupants of the vehicle, even if those occupants are well-restrained.

Accordingly, there is a need for improved vehicular safety systems, particularly systems and methods for mitigating the effects of sudden accelerative forces produced by mines and the like.

### BRIEF SUMMARY OF THE INVENTION

In accordance with one embodiment, a method of mitigating sudden accelerative forces experienced by a vehicle includes determining a dynamic response of the vehicle resulting from the sudden accelerative forces, determining whether mitigation is required based on the dynamic response of the vehicle, and, if it is determined that mitigation is required, activating one or more countermeasures to generate mitigating forces on the vehicle such that the sudden accelerative forces are at least partially counteracted.

An active blast mitigation system in accordance with one embodiment includes: one or more sensors configured to produce a set of acceleration signals indicative of a dynamic response of the vehicle; a control system communicatively coupled to the plurality of sensors, the control system configured to determine the dynamic response of the vehicle based on the set of acceleration signals, determine whether mitigation is required based on the dynamic response of the vehicle, and, if it is determined that mitigation is required, produce one or more countermeasure signals, the countermeasure signals selected to at least partially counteract the dynamic response; and a plurality of countermeasure assemblies communicatively coupled to the control system, the plurality of countermeasure assemblies configured to activate in response to the one or more countermeasure signals.

An active mine blast mitigation control system in accordance with one embodiment includes: an input interface configured to be coupled to one or more acceleration sensors and to receive a set of acceleration signals indicative of a dynamic response of a vehicle; an output interface configured to be coupled to one or more countermeasure assemblies and to transmit one or more countermeasure signals thereto; and a processor communicatively coupled to the input interface and the output interface, the processor configured to determine the dynamic response of the vehicle based on the set of acceleration signals, determine whether mitigation is required based on the dynamic response of the vehicle, and, if it is determined that mitigation is required, produce the one or more countermeasure signals.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary active mitigation system in accordance with an embodiment of the invention;

FIGS. 2A and 2B conceptually depict sudden accelerative forces and resulting vehicular dynamic response caused by a blast event;

FIGS. 3A and 3B conceptually depict sudden accelerative forces and vehicular dynamic response caused by a blast event in accordance with an exemplary active mitigation system;

FIG. 4 is a conceptual cross-sectional view of an active countermeasure assembly in accordance with one embodiment of the invention; and

FIG. 5 is a conceptual cross-sectional view of an active countermeasure assembly in accordance with an alternate embodiment of the invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

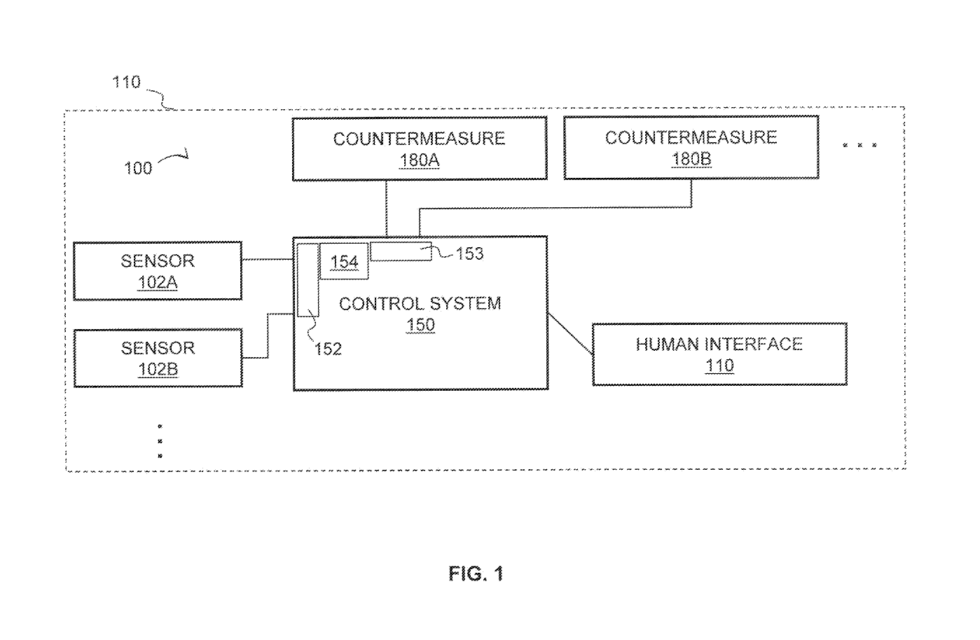

Referring now to FIG. 1, an active blast mitigation system 100 in accordance with one embodiment of the present invention generally includes one or more sensors 102 (102A, 102B, etc.), a control system 150, a plurality of countermeasure assemblies (or simply “countermeasures”) 180 (180A, 180B, etc.), and a human interface 110.

In general, sensors 102 are configured to produce a set of acceleration signals indicative of a dynamic response of a vehicle 110. Note that, for the purposes of simplicity, vehicle 110 is illustrated conceptually as a rectangle. Control system 150, which is communicatively coupled to the plurality of sensors 102 and countermeasures 180, is configured to determine the dynamic response of vehicle 110 based on the set of acceleration signals, then determine whether mitigation is required based on the dynamic response of the vehicle—e.g., whether the dynamic response of the vehicle likely to cause harm to occupants of the vehicle. If it is determined that mitigation is required, control system 150 produces one or more countermeasure signals selected to at least partially counteract the dynamic response (e.g., to counteract the effects of sudden accelerative forces applied to vehicle 110 by a mine blast). Countermeasures 180 then activate in response to the one or more countermeasure signals, thereby at least partially counteracting the dynamic response of vehicle 110.

Sensors 102 include any combination of sensor components, processors, and/or software configured to produce a set of acceleration signals indicative of a dynamic response of a vehicle 110. Sensors 102 may be communicatively coupled to control system 150 in any suitable fashion, including various wired or wireless communication methods known in the art. In one embodiment, sensors 102 are selected such that they can detect a blast event in approximately 10 milliseconds or less. An example sensor suitable for use with the present invention is the Measurement Specialties model MEAS 53-200 piezoresistive accelerometer, having an acceleration limit of 2000 g's and a frequency limit of about 5 kHz (200 microseconds per reading). Sensors 102 may be placed anywhere on, under, or within vehicle 110. In one embodiment, for example, sensors 102 are placed near at least three corners of vehicle 110 as well as near the center of the vehicle. In this way, both the translation and rotation of vehicle 110 with respect to various axes may be inferred via acceleration information received from sensors 102.

Control system 150 includes, in one embodiment, a processor 154 (e.g., one or more microprocessors, microcontrollers, or the like), an input interface 152, and an output interface 153. As will be apparent, in practical embodiments control system 150 will generally include any number of additional components, such as power supplies, memory and storage components, and the like. For the purposes of simplicity, such components are not illustrated in FIG. 1.

Input interface 152 is configured to be coupled to sensors 102, and to receive a set of acceleration signals indicative of the dynamic response of vehicle 110. Such signals may be digital or analog. Similarly, output interface 153 is configured to be coupled to countermeasures 180 and to transmit one or more countermeasure signals thereto. The countermeasure signals may also be either digital or analog. Processor 154 is communicatively coupled to input interface 152 and to output interface 153. Processor 154 is configured to determine the dynamic response of vehicle 110 based on the set of acceleration signals. Processor 154 is further configured to determine whether mitigation is required based on the dynamic response of the vehicle. If processor 154 determines that mitigation is required, it produces one or more countermeasure signals in order to activate the appropriate countermeasures 180.

Control system 150 may determine the dynamic response of vehicle 110 from acceleration signal in accordance with classical Newtonian physics, which are well known in the art. That is, since control system 150 will know a priori the location of sensors 102 with respect to the approximate center of mass of vehicle 110, as well as the vector acceleration at each of those points, control system 150 can resolve the vector quantities to determine the position, velocity, acceleration, instant center, and other common dynamic characteristics of the structure.

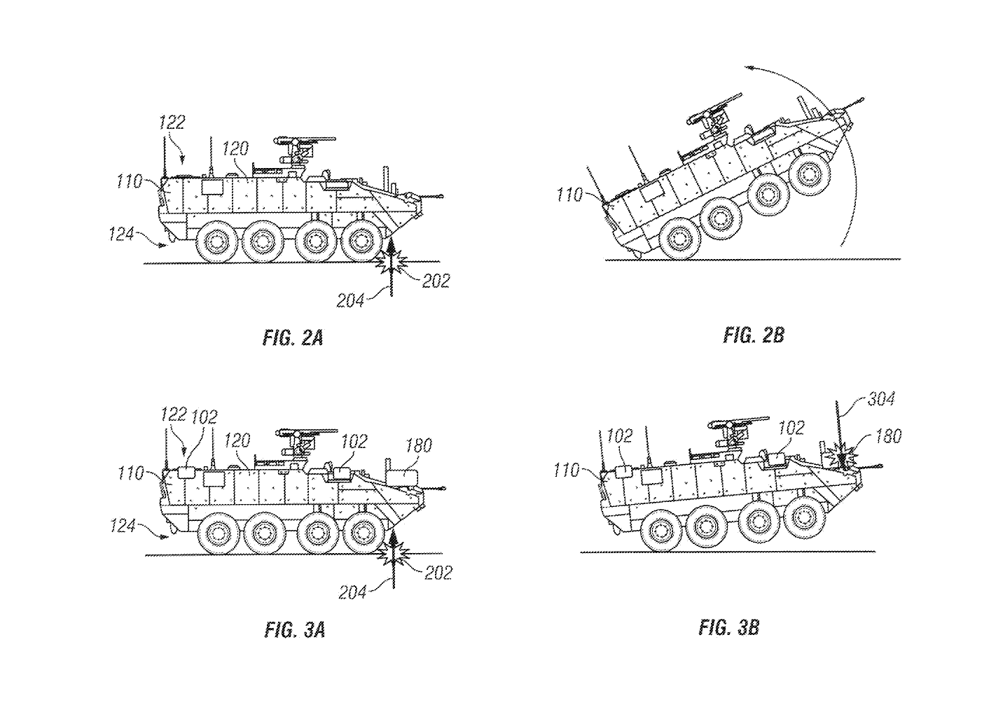

FIGS. 2A and 2B depict an exemplary vehicle 110 subject to a sudden accelerative force 204 produced by a blast (e.g., a mine blast) 202 without an active mitigation system as illustrated in FIG. 1. In this embodiment, vehicle 110 includes a hull 120, such that force 204 is primarily experienced by the underbelly 124 of hull 120 (FIG. 2A). For the purpose of this illustration, it is assumed that the right end of vehicle 110 corresponds to the “front end”, and that the left end of vehicle 110 corresponds to the “back end.” As a result of force 204, which is distant from the center of mass of vehicle 110 (not illustrated), the front end rises quickly such that vehicle 110 experiences a sudden rotation—i.e., a counter-clockwise rotation as illustrated in FIG. 2B. In general, the accelerative loading generated by the blast at a given location in vehicle 110 can be characterized by the value ΔV, which is the velocity change occurring at that location due to blast 202. For an off-center blast, a point closer to an end of the vehicle will have a larger value of ΔV than one closer to the center of mass, simply due to the effect of rotational dynamics. In some blast instances, the front end may rise at about 6.0 m/s and reach about two meters off the ground. As mentioned previously, such sudden acceleration can pose a severe risk to any occupants of vehicle 110.

FIGS. 3A and 3B, in contrast, depict an exemplary vehicle 110 subject to sudden accelerative force 204 produced by blast 202 with an active mitigation system as illustrated in FIG. 1. In FIG. 3A, two sensors 102 are illustrated as being mechanically coupled to hull 120 near one end of vehicle 110. It will be appreciated, however, that any number of such sensors 102 may be distributed on, under, or within vehicle 110. Similarly, while a single countermeasure 180 is illustrated as being coupled to hull 120 near the front end of vehicle 110, any number of such countermeasures may be employed.

As depicted in FIG. 3B, when the control system (not illustrated) determines that mitigation is required based on the dynamic response of the vehicle (e.g., based on the translation and rotation sensed via sensors 102), the control system produces and sends to countermeasure 180 a countermeasure signal to at least partially counteract the effects of sudden accelerative forces applied to vehicle 110 by mine blast 202. Countermeasure 180 then activates (e.g., via controlled explosion) in response to the countermeasure signal, producing a mitigating force 304 that at least partially counteracts force 204, thereby reducing the amplitude of rotation and/or translation experienced by vehicle 110. This is shown qualitatively by the relative rotation of vehicle 110 in FIGS. 2B and 3B.

Countermeasures 180 include any combination of hardware and/or software suitable to receive a signal from control system 150 and then activate in response to that signal. As with sensors 102, countermeasures 180 may be communicatively coupled to control system using any suitable wired or wireless communication method.

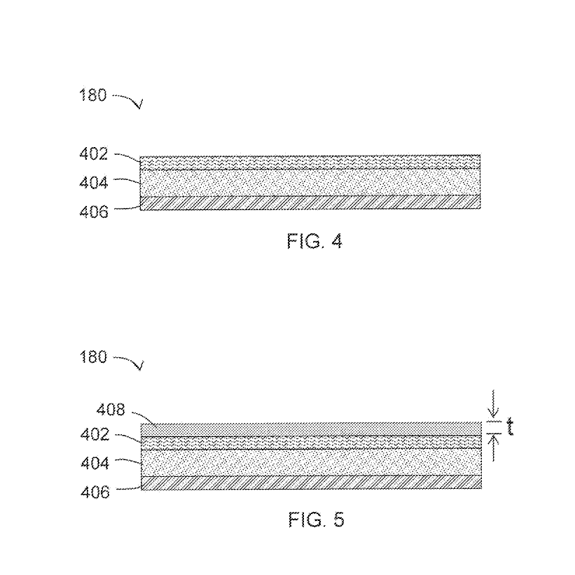

Referring to FIG. 4, an exemplary countermeasure 180 suitable for use in implementations of the present invention generally includes an armor layer 404 (e.g., a ceramic layer), a hull 406 (corresponding, for example, to hull 120 in FIGS. 3A and 3B), and an energetic material layer 402. Energetic material layer 402 generally comprises a material capable of reacting in a way that it imparts a force on the underlying structure (e.g., an explosive or propellant). In an alternate embodiment, as shown in FIG. 5, counter measure 180 further includes a tamping layer 408 (e.g., a steel, aluminum, or other frangible material layer), as may be seen in reactive armor structures. Tamping layer 408 serves two purposes: it protects energetic material layer 402 from environmental damage, and it increases the net reaction force of a given amount of energetic material. That is, the same amount of energetic material layer 402 will generate more reaction force when “tamped” than when “untamped”, and will reduce the total amount of energetic material needed to produce a given reaction load.

Energetic material layer 402 comprises, in various embodiments, either an explosive or a propellant. As is known in the art, an explosive reacts very quickly (often in less than a millisecond), and generates a focused (and possibly damaging) load over a small area in a very short time. In contrast, a propellant can be selected such that it reacts more slowly—for example, about 10-50 milliseconds or more—and thereby reduces the possibility of overstressing the underlying hull structure. In one embodiment, for example, energetic material layer 402 has a specific impulse of approximately 244 seconds (2395 N-s/kg), consistent with high-grade propellants. The thickness of energetic material layer 402 may also be selected in accordance with the desired effect. In one embodiment, energetic material layer 402 has a thickness of about 0.25 inches.

Materials suitable for implementing energetic material layer 402 include, for example, the Detasheet flexible rubberized energetic material manufactured by DuPont. Other non-explosive energetics such as a common aluminum-ammonium perchlorate propellant may also be used. In general, any energetic material layer 402 that is capable of producing a reaction force tailored to counteract the acceleration induced by the initial blast may be used. In one embodiment, the size, geometry, and material of countermeasures 180 are selected such that the structure can counter a 40 kN-s impulse, which roughly corresponds to a large underbelly mine blast.

Human interface 110 includes any combination of processors, memory, storage, displays, input devices (mice, keyboards, touch-screens, etc.) suitable for controlling operation of system 100. That is, the control system 150 is configured to determine the dynamic response, determine whether mitigation is required, and produce the countermeasure signals in accordance with commands received from the human interface. In one embodiment, human interface 110 also includes various indicators providing information regarding the status of sensors 102 and countermeasures 180. For example, human interface 110 might indicate whether and to what extent sensors 102 and countermeasures 180 are functional, and whether the system as a whole is armed or un-armed.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

1. A method of mitigating sudden accelerative forces experienced by a vehicle, comprising:
determining a dynamic response of the vehicle resulting from the sudden accelerative forces;
determining whether mitigation is required based on the dynamic response of the vehicle; and
if it is determined that mitigation is required, activating one or more countermeasures to generate mitigating forces on the vehicle such that the sudden accelerative forces are at least partially counteracted.

2. The method of claim 1, wherein determining the dynamic response comprises receiving a set of signals from one or more acceleration sensors mechanically coupled to the vehicle.

3. The method of claim 2, wherein the one or more acceleration sensors include a first acceleration sensor proximate a first end of the vehicle, and a second acceleration sensor proximate a second end of the vehicle.

4. The method of claim 1, wherein determining whether mitigation is required comprises determining whether the dynamic response of the vehicle has an amplitude that is greater than a predetermined threshold.

5. The method of claim 1, wherein determining whether mitigation is required comprises determining whether the dynamic response of the vehicle is likely to cause damage to an occupant within the vehicle.

6. The method of claim 1, further including determining the dynamic response, determining whether mitigation is required, and activating the one or more countermeasures is performed in accordance with commands received from a human interface.

7. The method of claim 1, wherein the dynamic response of the vehicle is characterized by a rotation and a translation of the vehicle, and wherein activating the one or more countermeasures includes activating one or more countermeasures coupled to a topside of the vehicle such that the mitigating forces at least partially counteract the rotation and the translation of the vehicle.

8. An active blast mitigation system for a vehicle, comprising:
one or more sensors configured to produce a set of acceleration signals indicative of a dynamic response of the vehicle;
a control system communicatively coupled to the plurality of sensors, the control system configured to determine the dynamic response of the vehicle based on the set of acceleration signals, determine whether mitigation is required based on the dynamic response of the vehicle, and, if it is determined that mitigation is required, produce one or more countermeasure signals, the countermeasure signals selected to at least partially counteract the dynamic response; and
a plurality of countermeasure assemblies communicatively coupled to the control system, the plurality of countermeasure assemblies configured to activate in response to the one or more countermeasure signals.

9. The system of claim 8, wherein the one or more sensors include a first acceleration sensor proximate a first end of the vehicle, and a second acceleration sensor proximate a second end of the vehicle.

10. The system of claim 8, wherein the control system is configured to determine whether mitigation is required by determining whether an amplitude of the dynamic response is above a predetermined threshold.

11. The system of claim 8, further including a human interface communicatively coupled to the control system, wherein the control system is configured to determine the dynamic response, determine whether mitigation is required, and produce the countermeasure signals in accordance with commands received from the human interface.

12. The system of claim 11, wherein the human interface further includes status indicators indicating which of the countermeasure assemblies and sensors are functional, and whether the active blast mitigation system is armed.

13. The system of claim 8, wherein the vehicle includes a hull, and wherein the plurality of countermeasure assemblies include at least one topside countermeasure assembly coupled to the top of the hull.

14. The system of claim 13, wherein the at least one topside countermeasure includes:
an armor layer coupled to an external surface of the hull; and
an energetic material layer coupled to the armor layer.

15. The system of claim 14, further including a tamping layer coupled to the energetic material layer.

16. The system of claim 15, wherein the armor layer comprises a ceramic, the tamping layer comprises steel, and the thickness of the tamping layer is selected to provide a predetermined mitigating force when activated.

17. An active mine blast mitigation control system, comprising:
an input interface configured to be coupled to one or more acceleration sensors and to receive a set of acceleration signals indicative of a dynamic response of a vehicle;
an output interface configured to be coupled to one or more countermeasure assemblies and to transmit one or more countermeasure signals thereto;
a processor communicatively coupled to the input interface and the output interface, the processor configured to determine the dynamic response of the vehicle based on the set of acceleration signals, determine whether mitigation is required based on the dynamic response of the vehicle, and, if it is determined that mitigation is required, produce the one or more countermeasure signals.

18. The control system of claim 16, wherein the processor is configured to determine whether mitigation is required by determining whether an amplitude of the dynamic response is above a predetermined threshold.

19. The control system of claim 16, wherein the processor is communicatively coupled to a human interface, and wherein the processor is configured to determine the dynamic response, determine whether mitigation is required, and produce the countermeasure signals in accordance with commands received from the human interface.

20. The control system of claim 16, wherein the control system is further configured to:
determine the dynamic response, determine whether mitigation is required, and produce the countermeasure signals in accordance with commands received from a human interface;
receive status information from the one or more countermeasure assemblies and the one or more sensors; and
transmit the status information to the human interface.
